(19) United States
(12) Patent Application Publication
(10) Pub. No.: US 2007/0211075 A1
(43) Pub. Date: Sep. 13, 2007

(54) Apparatus and method for converting RGB data in wireless terminal

(75) Inventors: Jeong-Wook Seo, Suseong-gu (KR); Wei-Jin Park, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/705,573

(22) Filed: Feb. 12, 2007

(30) Foreign Application Priority Data
Feb. 11, 2006 (KR) 13347-2006

(51) Int. Cl. G09G 5/02

(52) U.S. Cl. 345/604

(57) ABSTRACT

Disclosed is an apparatus for converting Y, U and V data to R, G and B data, the apparatus including a YUV buffer for receiving and outputting the Y, U and V data; an R computation unit for receiving the Y and V data and computing an R data value R≈Y>>3+{(V×9)>>6}; a G computation unit for receiving the Y, U and V data and computing a G data value by G≈(Y>>2)−{(U×11)>>7}−{(V×23)>>7}; a B computation unit for receiving the Y and U data and computing a B data value B≈(Y>>3)−{(U×7)>>5}; and an arrangement unit for arranging the R, G and B data values, where >> represents a shift operator.

### PRIORITY

This application claims priority to an application entitled “Apparatus And Method For Converting RGB Data In Wireless Terminal” filed in the Korean Intellectual Property Office on Feb. 11, 2006 and assigned Serial No. 2006-13347, the contents of which are incorporated herein by reference.

### BACKGROUND OF THE INVENTION

1. Field of the Invention

The present invention relates to an additional apparatus in a wireless terminal, and more particularly to an apparatus and a method for converting YUV data, which correspond to raw data, to RGB data.

2. Description of the Related Art

Generally, YUV data (data displayed as light and darkness/color difference information) is used as raw data for a coder and decoder according to the usage in analog TV transmissions.

However, input of a display device used for digital media mainly uses RGB data (data displayed by three primary colors). Since the input and output between YUV data and RGB data are different, the output unit of a decoder converts YUV data to RGB data for output. When the decoder converts the YUV data to the RGB data, the burden of the decoder grows heavier because the amount of data to be operated increases.

According to an existing method for converting YUV data to RGB data, there exists an equation requiring a floating point operation. Equations (1) to (3) below obtained by simplifying this equation by an integer operation have been used for an integer operation processor. Equations (1) to (3) are as follows.
R≈Y+V+(V)3)+(V)5) Equation (1)
where, ≈ is an approximate value symbol, and >>: shift operator
G≈Y−(U>>1)+(U>>3)+(V>>5)−V+(V>>2)+(V>>5) Equation (2)
>>: shift operator
B≈Y−U−(U>>1)−(U>>2) Equation (3)
>>: shift operator

In operations using Equations (1) to (3), when respective YUV input is 8 bits, 24-bit RGB output is obtained. However, since RGB output required in an actual embedded environment is a 16-bit output, and R/G/B has 5/6/5 bits respectively, when Equations (1) to (3) are used, a partial combination of R/G/B 5/6/5 bits must be performed after a 8-bit operation. Therefore, the number of operations increases and the processing speed may be decreased.

### SUMMARY OF THE INVENTION

Accordingly, the present invention has been made to solve at least the above-mentioned problems occurring in the prior art, and an object of the present invention is to provide an apparatus and a method for converting YUV data to RGB data by means of a multiplication operation in a wireless terminal.

In accordance with one aspect of the present invention, there is provided an apparatus for converting Y, U and V data to R, B and B data, the apparatus including a YUV buffer for receiving and outputting the Y, U and V data; an R computation unit for receiving the Y and V data and computing an R data value where R≈Y>>3+{(V×9)>>6}; a G computation unit for receiving the Y, U and V data and computing a G data value where G≈(Y>>2)−{(U×11)>>7}−{(V×23)>>7}; a B computation unit for receiving the Y and U data and computing a B data value where B≈(Y>>3)−{(U×7)>>5}; and an arrangement unit for arranging the computed R, G and B data values, where >> represents a shift operator.

In accordance with another aspect of the present invention, there is provided a method for converting Y, U and V data to R, B and B data, the method including receiving the Y, U and V data; converting the Y and V data to an R data value where R≈Y>>3+{(V×9)>>6}; converting the Y, U and V data to a G data value where G≈(Y>>2)−{(U×11)>>7}−{(V×23)>>7}; converting the Y and U data to a B data value where B≈(Y>>3)−{(U×7)>>5}; and arranging and outputting the converted R, G and B data values, where >> represents a shift operator.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a wireless terminal according to the present invention;

FIG. 2 is a block diagram illustrating the construction of the decoder in FIG. 1;

FIGS. 3A to 3C are diagrams illustrating the detailed constructions of the red computation unit, the green computation unit and the blue computation unit in FIG. 2;

FIG. 4 is a flow diagram illustrating a process for converting YUV data to RGB data in a wireless terminal according to the present invention; and

FIGS. 5A to 5C are flow diagrams illustrating in detail the R, G; B data conversion processes in FIG. 4.

### DETAILED DESCRIPTION OF THE PREFERRED EMBODIMENT

A preferred embodiment of the present invention will be described in detail herein below with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

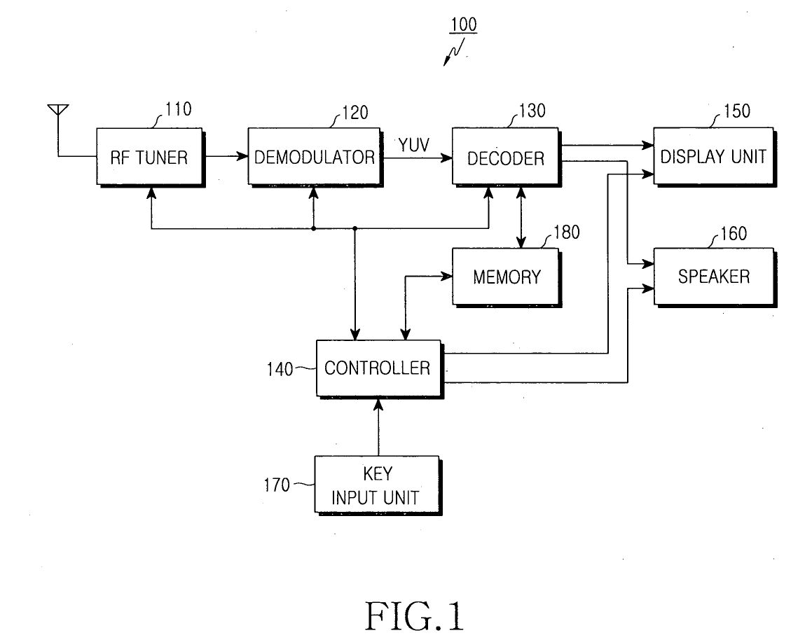

FIG. 1 is a block diagram illustrating the construction of a wireless terminal according to the present invention.

Referring to FIG. 1, the wireless terminal includes an RF tuner 110, a demodulator 120, a decoder 130, a controller 140, a display unit 150, a speaker 160, a key input unit 170 and a memory 180. The decoder 130 may also be embedded in the controller 140. In such a case, it is possible to realize the decoding performance of the wireless terminal by software.

The RF tuner 110 controls the transmission/reception of image and control data, which include voice data, text data and digital broadcasting signals, under the control of the controller 140. The RF tuner 110 includes an RF transmitter (not shown) for up-converting and amplifying the frequency of transmitted signals, an RF receiver (not shown) for low-noise amplifying received signals and down-converting the frequency of the received signals, etc.

The demodulator 120 demodulates modulated image signals into the original signals.

When broadcasting signals are received, the decoder 130 divides the broadcasting signals demodulated by the demodulator 120 into image and audio signals, decodes the divided image and audio signals, and outputs the decoded signals.

The controller 140 controls the general operations of the wireless terminal 100.

The display unit 150 may use a Liquid Crystal Display (LCD), etc., and outputs various display data generated in the wireless terminal 100. Herein, when the LCD has a touch screen function, the display unit 150 may also operate as an input unit.

The speaker 160 reproduces the audio signals, which are processed by the decoder 130, under the control of the controller 140.

The key input unit 170 includes a character key, a numeral key, various function keys and an external volume key, and outputs key input signals corresponding to keys input by a user to the controller 140.

The memory 180 may include a program memory and a data memory, and stores various information, which is necessary for controlling operations of the wireless terminal 100, and user storage information according to the present invention.

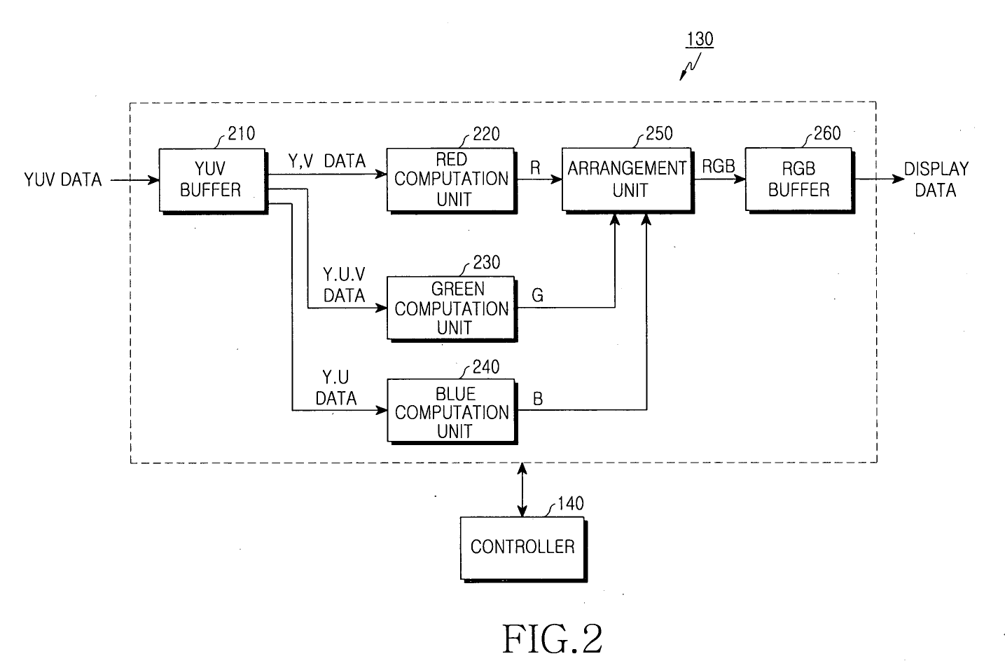

Hereinafter, the construction of the decoder 130 in the wireless terminal 100 having the construction as described above will be described in detail with reference to FIG. 2.

FIG. 2 is a block diagram illustrating the construction of the decoder 130 in the wireless terminal 100 of FIG. 1.

Referring to FIG. 2, the decoder 130 includes a YUV buffer 210, a red computation unit 220, a green computation unit 230, a blue computation unit 240, an arrangement unit 250 and an RGB buffer 260.

The YUV buffer 210 outputs input image signals, e.g., YUV data, to the red computation unit 220, the green computation unit 230 and the blue computation unit 240.

The red computation unit 220 receives Y and V data among the YUV data, which are output from the YUV buffer 210, under the control of the controller 140, and computes an R data value by means of Equation 4 below.
R≈Y>>3+{(V×9)>>6} Equation 4
>>: shift operator

The green computation unit 230 receives Y, U and V data among the YUV data, which are output from the YUV buffer 210, under the control of the controller 140, and computes a G data value by means of Equation 5 below.
G≈(Y>>2)−{(U×11)>>7}−{(V×23)>>7} Equation 5
>>: shift operator

The blue computation unit 240 receives Y and U data among the YUV data, which are output from the YUV buffer 210, under the control of the controller 140, and computes a B data value by means of Equation 6 below.
B≈(Y>>3)−{(U×7)>>5} Equation 6
>>: shift operator

The arrangement unit 250 arranges and outputs the R, G and B data values respectively computed by the red computation unit 220, the green computation unit 230 and the blue computation unit 240.

The RGB buffer 260 outputs the R, G and B data, which are output from the arrangement unit 250, as the display data of the wireless terminal 100.

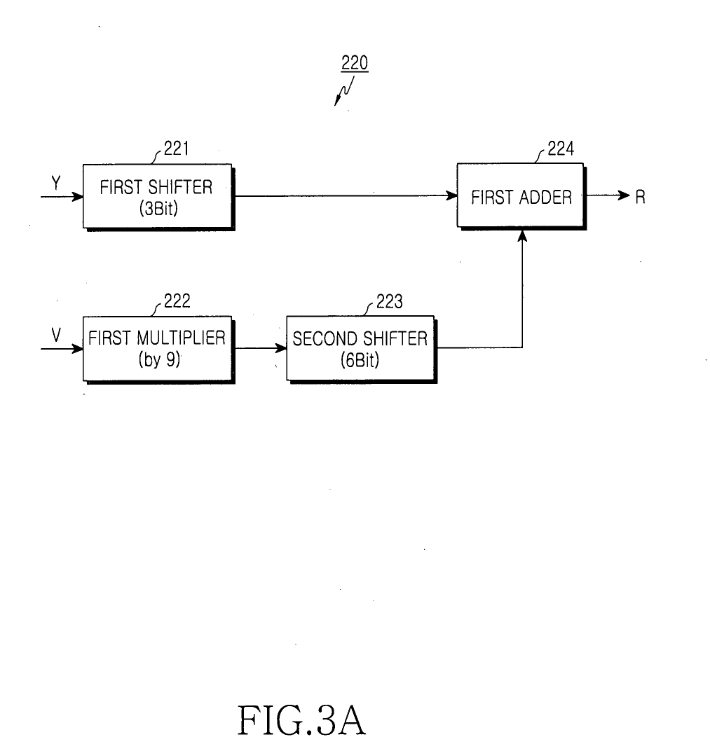

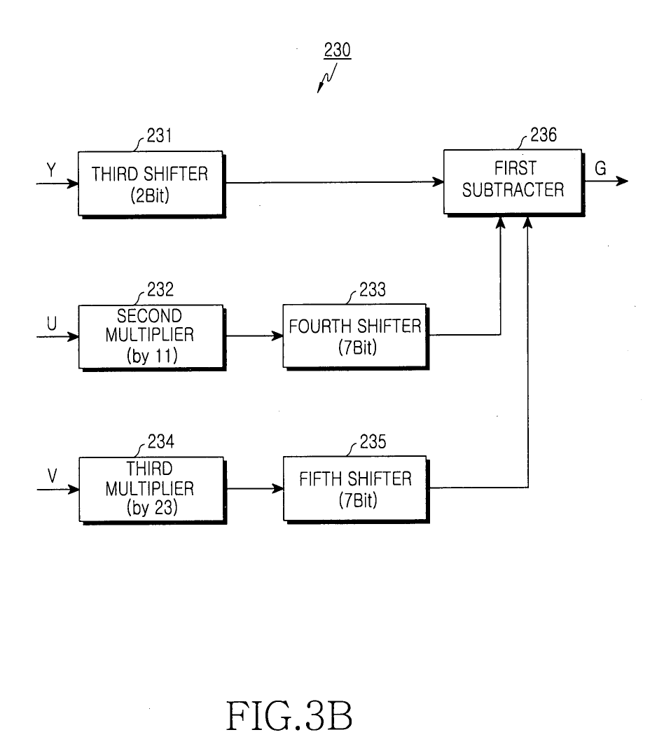

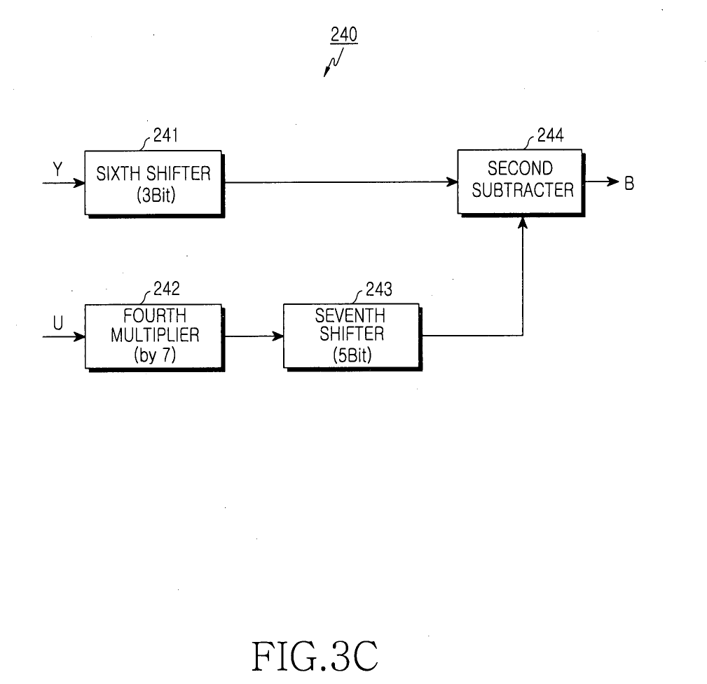

A process for computing the R, G and B data values in FIG. 2 will be described with reference to FIGS. 3A to 3C.

FIGS. 3A to 3C are diagrams illustrating the detailed constructions of the red computation unit 220, the green computation unit 230 and the blue computation unit 240 in the decoder 130.

Referring to FIG. 3A, the red computation unit 220 includes a first shifter 221 for shifting the Y data, a first multiplier 222 for multiplying V data by a predetermined value, a second shifter 223 for shifting the V data, and a first adder 224 for adding the Y data, which are shifted by the first shifter 221, to the V data shifted by the second shifter 223.

Hereinafter, a process in which the red computation unit 220 computes the R data value by means of Equation 4 will be described.

First, if the Y data are input, the first shifter 221 shifts the Y data by 3 bits and outputs the shifted Y data to the first adder 224.

If the V data are input, the first multiplier 222 multiplies the input V data by 9 and outputs the V data, which are multiplied by 9, to the second shifter 223.

The second shifter 223 shifts the V data by 6 bits, and outputs the shifted V data to the first adder 224.

The first adder 224 adds the Y data, which are output from the first shifter 221, to the V data output from the second shifter 223, thereby computing the R data value.

Then, the first adder 224 outputs the computed R data value to the arrangement unit 250 in FIG. 2.

Referring to FIG. 3B, the green computation unit 230 includes a third shifter 231 for shifting the Y data, a second multiplier 232 for multiplying the U data by a predetermined value, a fourth shifter 233 for shifting the U data received from the second multiplier 232, a third multiplier 234 for multiplying the V data by a predetermined value, a fifth shifter 235 for shifting the V data received from the third multiplier 234, and a first subtracter 236 for subtracting the U and V data, which are shifted by the fourth shifter 233 and the fifth shifter 235, from the Y data shifted by the third shifter 231.

Hereinafter, a process in which the green computation unit 230 computes the G data value by means of Equation 5 will be described.

First, if the Y data are input, the third shifter 231 shifts the Y data by 2 bits and outputs the shifted Y data to the first subtracter 236.

If the U data are input, the second multiplier 232 multiplies the U data by 11 and outputs the U data, which are multiplied by 11, to the fourth shifter 233.

The fourth shifter 233 shifts the U data by 7 bits and outputs the shifted U data to the first subtracter 236.

If the V data are input, the third multiplier 234 multiplies the V data by 23, and outputs the V data, which are multiplied by 23, to the fifth shifter 235.

The first subtracter 236 subtracts the U and V data, which are shifted by the fourth shifter 233 and the fifth shifter 235, from the Y data shifted by the third shifter 231, thereby computing the G data value.

Then, the first subtracter 236 outputs the computed G data value to the arrangement unit 250 in FIG. 2.

Referring to FIG. 3C, the blue computation unit 240 includes a sixth shifter 241 for shifting the Y data, a fourth multiplier 242 for multiplying the U data by a predetermined value, a seventh shifter 243 for shifting the U data received from the fourth multiplier 242, and a second subtracter 244 for subtracting the U data, which are shifted by the seventh shifter 243, from the Y data shifted by the sixth shifter 241.

Hereinafter, a process in which the blue computation unit 240 computes the B data value by means of Equation 6 will be described.

First, if the Y data are input, the sixth shifter 241 shifts the Y data by 3 bits and outputs the shifted Y data to the second subtracter 244.

If the U data are input, the fourth multiplier 242 multiplies the U data by 7 and outputs the U data, which are multiplied by 7, to the seventh shifter 243.

The seventh shifter 243 shifts the U data by 5 bits, and outputs the shifted U data to the second subtracter 244.

The second subtracter 244 subtracts the U data, which are shifted by the seventh shifter 243, from the Y data shifted by the sixth shifter 241, thereby computing the B data value. Then, the second subtracter 244 outputs the computed B data value to the arrangement unit 250 in FIG. 2.

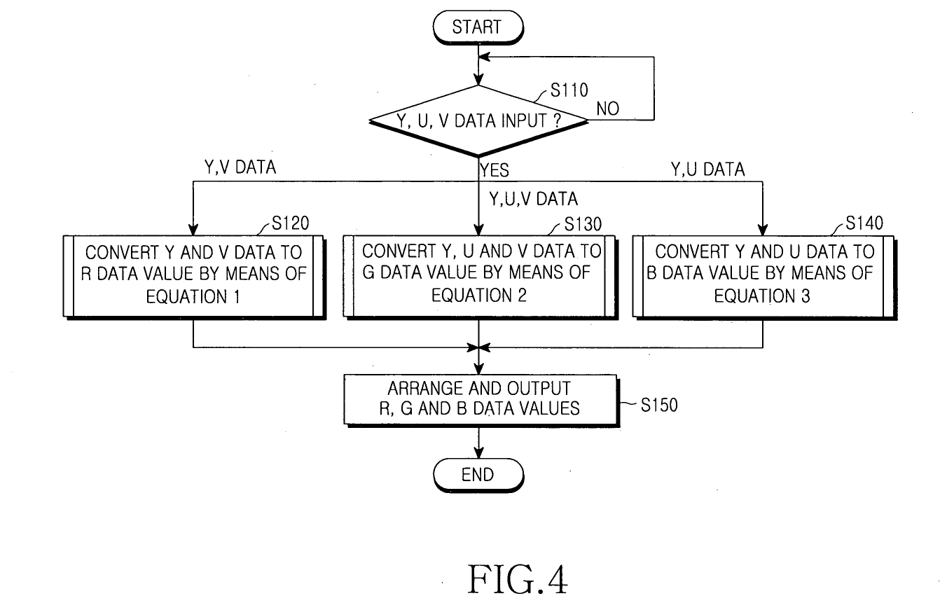

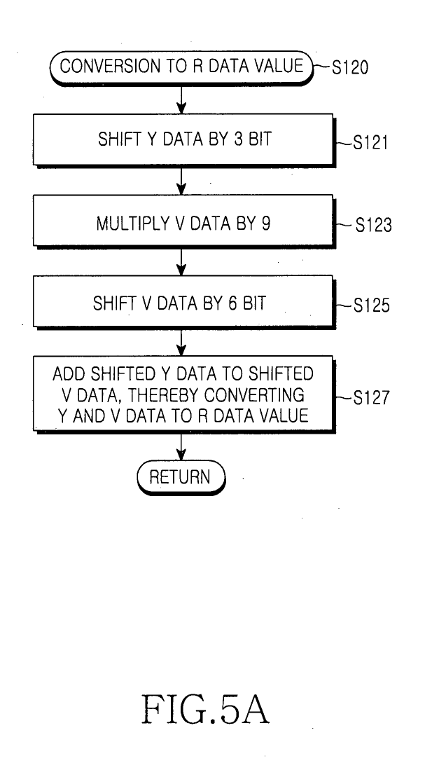

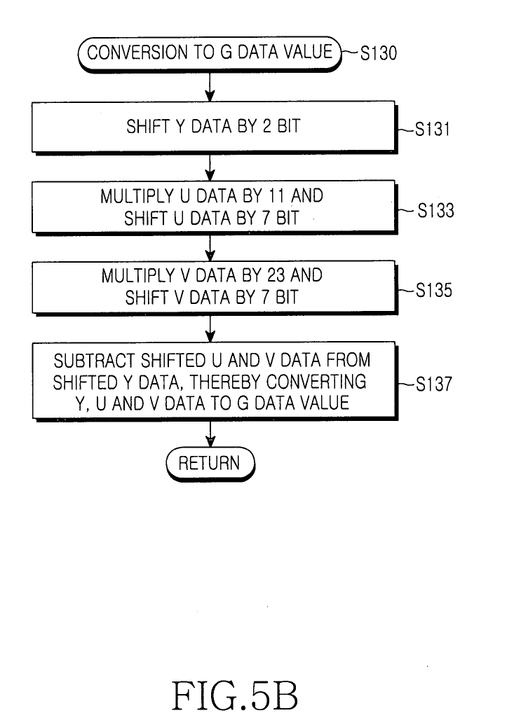

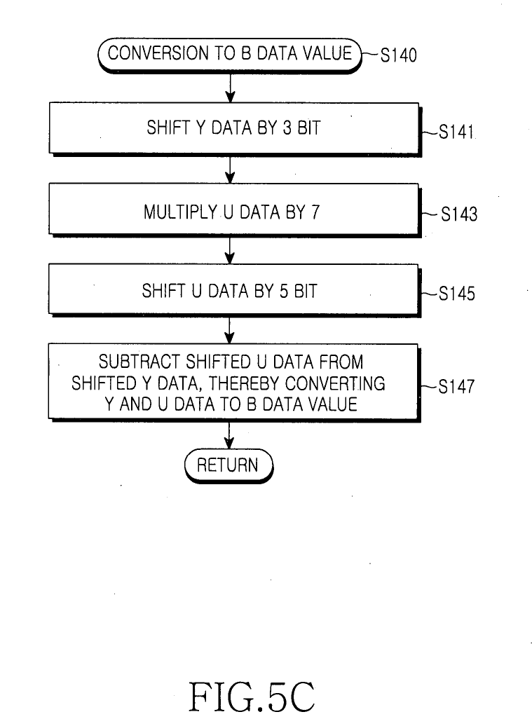

FIG. 4 is a flow diagram illustrating a process for converting YUV data to RGB data in the wireless terminal according to the present invention, and FIGS. 5A to 5C are flow diagrams illustrating in detail the R, G, B data conversion process in FIG. 4.

Referring to FIGS. 2 to 5C, the controller 140 determines if the YUV data is input (S110).

If the YUV data is input, the controller 140 converts the Y and V data of the input YUV data to the R data value (S120). Hereinafter, this process in which the decoder 130 converts the Y and V data to the R data value by means of Equation 4 will be described in detail with reference to FIG. 5A.

The R data value is computed by the red computation unit 220 of the decoder 130. The red computation unit 220 shifts the Y data by 3 bits through the first shifter 221 (S121).

The red computation unit 220 multiplies the input V data by 9 through the first multiplier 222 (S123).

The red computation unit 220 shifts the V data, which is multiplied by 9, by 6 bits through the second shifter 223 (S125).

The red computation unit 220 adds the Y data, which are output from the first shifter 221, to the V data, which is output from the second shifter 223, through the first adder 224, thereby converting the Y and V data to the R data value (S127). Accordingly, it is possible to simply convert the YUV data having input of 8 bits to the R data value of 5 bits.

Further, if the YUV data are input, the controller 140 controls the decoder 130 to convert the Y, U and V data among the input YUV data to the G data value (S130). Hereinafter, this process in which the decoder 130 converts the Y, U and V data to the G data value by means of Equation 2 will be described in detail with reference to FIG. 5B.

The G data value is computed by the green computation unit 230 of the decoder 130. The green computation unit 230 shifts the Y data by 2 bits through the third shifter 231 (S131).

The green computation unit 230 multiplies the input U data by 11 through the second multiplier 232, and shifts the U data by 7 bits by means of the fourth shifter 233 (S133).

The green computation unit 230 multiplies the V data by 23 through the third multiplier 234, and shifts the V data by 7 bits by means of the fifth shifter 235 (S135).

The green computation unit 230 subtracts the U and V data, which are shifted by the fourth shifter 233 and the fifth shifter 235, from the Y data, which are shifted by the third shifter 231, through the first subtracter 236, thereby converting the Y, U and V data to the G data value (S137). Accordingly, it is possible to simply convert the YUV data having input of 8 bits to the G data value of 6 bits.

Further, if the YUV data are input, the controller 140 controls the decoder 130 to convert the Y and U among the input YUV data to the B data value (S140). Hereinafter, this process in which the decoder 130 converts the Y and U data to the B data value by means of Equation 6 will be described in detail with reference to FIG. 5C.

The B data value is computed by the blue computation unit 240 of the decoder 130. The blue computation unit 240 shifts the Y data by 3 bits through the sixth shifter 241 (S141).

The blue computation unit 240 multiplies the input U data by 7 through the fourth multiplier 242 (S143).

The blue computation unit 240 shifts the U data by 5 bits through the seventh shifter 243 (S145).

The blue computation unit 240 subtracts the U data, which are shifted by the seventh shifter 243, from the Y data, which are shifted by the sixth shifter 241, through the second subtracter 244, thereby converting the Y and U data to the B data value (S147). Accordingly, it is possible to simply convert the YUV data having input of 8 bits to the B data value of 5 bits.

Then, the controller 140 arranges the converted R, G and B data values and outputs the arranged R, G and B data values as display data (S150).

In a case in which the present invention is realized by software, it is also possible to store conversion values in a memory so that the R/G/B values for the Y/U/V values can be directly obtained, and to use the conversion values. Herein, when the R/G/B exist in separate tables, the R/G/B may be stored in three ways according to the characteristics of a memory area.

In the first method, R/G/B tables are arranged in 8-bit memory areas, respectively, and a shift operation and a multiplication operation are performed in each addition.

In the second method, R/G/B tables are arranged in 16-bit memory areas, respectively, previously shifted types are stored, and an addition is performed by means of a multiplication operation.

In the third method, a Y value commonly existing in the equations of R/G/B is used. That is, when conversion tables of the R/G/B are generated, the tables are generated only for U and V values. Then, a Y table is separately applied to a 16-bit RGB value computed according to the above process, and then compensation is accomplished by offset.

According to the present invention as described above, as compared to existing equations used when YUV data are converted to RGB data, the total number of operations for converting R, G, B data values can be reduced from 25 to 15. Further, a processing speed can also be reduced from 48 Million Instruction Per Second (MIPS) to 28.8 MIPS. Consequently, in a wireless terminal, it is possible to simply convert YUV data to RGB data by means of a multiplication operation.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An apparatus for converting Y, U and V data to R, G and B data, the apparatus comprising:
a YUV buffer for receiving and outputting the Y, U and V data;
an R computation unit for receiving the Y and V data and computing an R data value where R≈Y>>3+{(V×9)>>6};
a G computation unit for receiving the Y, U and V data and computing a G data value where G≈(Y>>2)−{(U×11)>>7}−{(V×23)>>7};
a B computation unit for receiving the Y and U data and computing a B data value where B≈(Y>>3)−{(U×7)>>5}; and
an arrangement unit for arranging the computed R, G and B data values,
where >> represents a shift operator.

2. The apparatus as claimed in claim 1, wherein the R computation unit comprises:
a first shifter for shifting the Y data;
a first multiplier for performing a multiplication operation for the V data;
a second shifter for shifting the V data output from the first multiplier; and
a first adder for adding the Y data, which are shifted by the first shifter, to the V data shifted by the second shifter.

3. The apparatus as claimed in claim 1, wherein the G computation unit comprises:
a third shifter for shifting the Y data;
a second multiplier for performing a multiplication operation for the U data;
a fourth shifter for shifting the U data output from the second multiplier;
a third multiplier for performing a multiplication operation for the V data;
a fifth shifter for shifting the V data output from the third multiplier; and
a first subtracter for subtracting the U and V data, which are respectively shifted by the fourth shifter and the fifth shifter, from the Y data shifted by the third shifter.

4. The apparatus as claimed in claim 1, wherein the B computation unit comprises:
a sixth shifter for shifting the Y data;
a fourth multiplier for performing a multiplication operation for the U data;
a seventh shifter for shifting the U data output from the fourth multiplier; and
a second subtracter for subtracting the U data, which are shifted by the seventh shifter, from the Y data shifted by the sixth shifter.

5. A method for converting Y, U and V data to R, G and B data, the method comprising:
receiving the Y, U and V data;
converting the Y and V data to an R data value where R≈Y>>3+{(V×9)>>6};
converting the Y, U and V data to a G data value where G≈(Y>>2)−{(U×11)>>7}−{(V×23)>>7};
converting the Y and U data to a B data value where B≈(Y>>3)−{(U×7)>>5}; and
arranging and outputting the converted R, G and B data values,
where >> represents a shift operator.

6. The method as claimed in claim 5, wherein the step of converting the Y and V data to the R data value comprises:
shifting the Y data;
performing a multiplication operation for the V data;
shifting the V data; and
adding the Y data, which are shifted in the shifting of the Y data step, to the V data shifted in the shifting of the V data step, thereby converting the Y and V data to the R data value.

7. The method as claimed in claim 5, wherein the step of converting the Y, U and V data to the G data value comprises:
shifting the Y data;
performing a multiplication operation for the U data;
shifting the U data;
performing a multiplication operation for the V data;
shifting the V data; and
subtracting the U and V data, which are respectively shifted in the shifting of the U data step and the shifting of the V data step, from the Y data shifted in the shifting of the Y data step, thereby converting the Y, U and V data to the G data value.

8. The method as claimed in claim 5, wherein the step of converting the Y and U data to a B data value comprises:
shifting and outputting the Y data;
performing a multiplication operation for the U data;
shifting and outputting the U data; and
subtracting the U data, which are outputted in the shifting and outputting of the U data step, from the Y data outputted in the shifting and outputting of the Y data step, and thereby outputting the B data value.
